(19) United States
(12) Patent Application Publication
(10) Pub. No.: US 2020/0391987 A1
(43) Pub. Date: Dec. 17, 2020

(54) INDUSTRIAL TRUCK WITH A VEHICLE CONTROL FOR AUTOMATIC OPERATION AND ASSOCIATED METHOD

(71) Applicant: Jungheinrich Aktiengesellschaft, Hamburg (DE)

(72) Inventor: Dennis Flottran, Breitenfelde (DE)

(73) Assignee: Jungheinrich Aktiengesellschaft, Hamburg (DE)

(21) Appl. No.: 16/898,662

(22) Filed: Jun. 11, 2020

(30) Foreign Application Priority Data
Jun. 11, 2019 (DE) 10 2019 115 864.8

(51) Int. Cl. B66F 17/00; B66F 9/075; B66F 9/06; B66F 9/18

(52) U.S. Cl. CPC B66F 17/003; B66F 9/18; B66F 9/063; B66F 9/0755

(57) ABSTRACT

An industrial truck comprises a vehicle control, a lifting member, and a drive system configured for automatic operation. A personal safety system comprises a distance measuring apparatus and is configured to detect and evaluate at least one safety zone in front of the lifting member. The distance measuring apparatus is configured to obtain distance data on objects and obstacles within the at least one safety zone. The vehicle control is configured to at least one of deposit and pick up a plurality of load carriers positioned at a predetermined distance from each other. The vehicle control is configured to access the distance data of the personal safety system in order to automatically control the lifting member and the drive system.

### CROSS REFERENCE TO RELATED INVENTION

This application is based upon and claims priority to, under relevant sections of 35 U.S.C. § 119, German Patent Application No. 10 2019 115 864.8, filed Jun. 11, 2019, the entire contents of which are hereby incorporated by reference.

### BACKGROUND

The present invention relates to an industrial truck which has a vehicle control for automatic operation.

Industrial trucks whose vehicle control is suitable for automatic operation are increasingly being used in logistics. Such vehicles are occasionally also termed automated guided vehicles (AGV). Depending on the degree of automation, a distinction can be made here between partially and fully automated vehicles. The differing degree of automation refers especially in this case to the tasks that can be performed automatically by the industrial truck. Automated vehicles are always equipped with a personal safety system for reasons of safety. The personal safety system recognizes the danger of a potential collision with a person or an object and correspondingly intervenes in the control; this can for example be done by braking the vehicle and/or by an evasive maneuver by the vehicle. Personal safety systems always possess a distance measuring apparatus with which the surroundings of the vehicle are detected, and distances to obstacles and persons are also detected while driving. In order to be able to ensure proper functioning of the personal safety system, one or more safety zones are defined for the distance measuring apparatus, or respectively the personal safety system. The safety zone therefore designates a spatial region in the surroundings of the vehicle that must be free of obstacles, persons and other objects so that automatic operation, especially travel, can occur.

Such industrial trucks whose vehicle control is suitable for automatic operation are constructed such that there is a load bearing means controlled in automatic operation and a drive system controlled in automatic operation. Of course, in this case control can be performed manually by corresponding operating elements for non-automatic operation; it can also be provided that manual intervention in the operating elements supersedes automatic control.

In storage technology, the term block storage designates storing goods without shelves, or a comparable design. In block storage, a distinction can be made between horizontal storage and vertical stacking, wherein with vertical block storage, the goods to be stored are placed directly upon each other. With horizontal block storage, the goods are placed next to each other on a level. In this case, it is desirable to maintain given distances between the goods with horizontal block storage.

### BRIEF SUMMARY OF THE INVENTION

The object of the invention is to provide an industrial truck suitable for automatic operation that can support block storage.

The invention relates to an industrial truck with a vehicle control suitable for automatic control or automatic operation. In an embodiment, an industrial truck comprises a load bearing means, or load lifting member, controlled in automatic operation, a drive controlled in automatic operation, and a personal safety system. The personal safety system evaluates at least one safety zone in front of the load bearing means, wherein the personal safety system has a distance measuring apparatus which detects distance data on objects and obstacles within the at least one safety zone. According to the invention, it is provided for the vehicle control to be designed to deposit and/or pick up a plurality of load carriers at a predetermined distance from each other. This means that the vehicle control is designed to automatically perform this process which comprises depositing and/or picking up a plurality of load carriers. In a particular easy form, this is possible by accessing the distance data of the personal safety system to automatically control load bearing means and the drive system. The invention is therefore founded on the concept of not detecting the data needed for horizontal block storage by separate sensors, but rather also using the already existing sensor system with the distance measuring data of the personal safety system for this task. It is key in this case that the function of the personal safety system is not restricted; instead, the distance data of the personal safety system can be accessed without restricting its evaluation with respect to personal safety.

In a preferred embodiment, the personal safety system is configured to directly evaluate the distance data detected by the distance measuring apparatus for the vehicle control. In this embodiment, the personal safety system hence provides the obtained distance data as raw values for the vehicle control. For horizontal block storage, it has proven to be advantageous to provide a teach-in function for the vehicle control and/or the personal safety system in which the desired distance is manually approached and saved for automatic operation. The obtained distance data in this approach are also evaluated with respect to personal safety and processed as such. Through the teach-in process in which the industrial truck is manually controlled for the desired movement, corresponding limit values and threshold values can be set for the parameters and distance values so that the vehicle control repeats the procedure from the teach-in process in automatic operation.

In an alternative or additional approach, it can be provided for the safety zone or individual safety zones to be dimensioned with respect to their placement and their distances to correspond to the desired distances for the load carrier. In this approach, it is then no longer necessary for there to be a double processing of the distance data; instead, the processing of the distance data is accessed for the task of horizontal block storage as well as for personal safety.

In a preferred development, it is provided to control the drive system for automatic driving until the personal safety system and/or the vehicle control has recognized the predetermined distance. This embodiment ensures that the vehicle can automatically drive from a first deposit or storage point to the next storage point. Once the predetermined distance is recognized, the next storage position then exists so that the next load can be deposited or picked up. In an embodiment, a laser scanner is provided as a distance measuring apparatus that is usefully oriented toward the load bearing means.

In another embodiment, safety zones can differ depending on the task. It can accordingly be provided that a first safety zone is provided for personal safety, in particular for personal safety with a predetermined protection class, such as according to DIN EN 1525. At least one second safety zone can be configured with respect to its placement and/or its dimensions for an automated deposit/pickup process. Personal safety and automatic operation can thereby be controlled by the safety zones. Depending on the placement and mutual overlap of the safety zones, it can also be advantageous if the first safety zone is turned off for an automatic deposit/pickup process. Turning off the first safety zone does not result in reduced personal safety since personal safety can already be realized by the spatial situation given a suitable placement of the second safety zone, even if the second safety zone is configured for controlling the automated deposit/pickup process.

### BRIEF DESCRIPTION OF THE DRAWINGS

A preferred embodiment of the invention is explained below based on an exemplary embodiment. In the figures:

FIG. 1 illustrates a schematic depiction of an embodiment of automated vehicle comprising three load carriers; and

FIG. 2 illustrates a flowchart for the process of horizontal block storage occurring in the vehicle control.

### DETAILED DESCRIPTION OF THE INVENTION

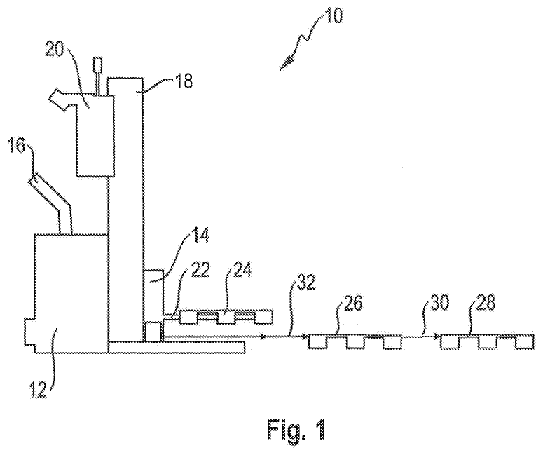

FIG. 1 shows a schematic view of an automated vehicle 10 that has a load part 14 and a drive part 12. The drive part 12 is equipped with a control element 16 which permits manual control of the industrial truck 10 with respect to direction and driving speed. Other functional units such as lifting and lowering as well as honking can be actuated by the control element 16. The drive part 12 also has a drive motor as well as at least one driven and steered wheel (not shown).

The load part 14 in the portrayed exemplary embodiment has a lift mast 18 to which the vehicle control 20 is attached. The vehicle control 20 can for example be additionally equipped with warning lights and have a radio link to a warehouse management system. The lift mast 18 possesses a load bearing means 22 configured to move along or relative to the lift mast 18. As shown in FIG. 1, the load bearing means 22 is portrayed in the lifted position. The load bearing means 22 or lead lifting member may comprise two load forks running parallel to each other. The load bearing means 22 is portrayed in a slightly lifted position in FIG. 1 with a pallet 24 without a load.

The horizontal block storage that is depicted in FIG. 1 consists for example of the pallets 24, 26 and 28. The same distance 32 is always provided between these pallets. As the portrayed block storage is for example built up, the industrial truck 10 first deposits the pallet 28. Then the industrial truck drives back along the length 30 using its drive system (opposite the direction of the arrow) in order to deposit the pallet 26 there. After another trip along the length (opposite its direction of the arrow), the vehicle is located in the portrayed position and can deposit the pallet 24 there. The horizontal block storage of the pallets 24, 26, 28 arises in this manner. The above procedure is of course such that the industrial truck can automatically drive through the warehouse after depositing the pallets 26 in order to pick up the pallet 24 at another location, and then the industrial truck returns to the position. The same holds true when picking up the pallets.

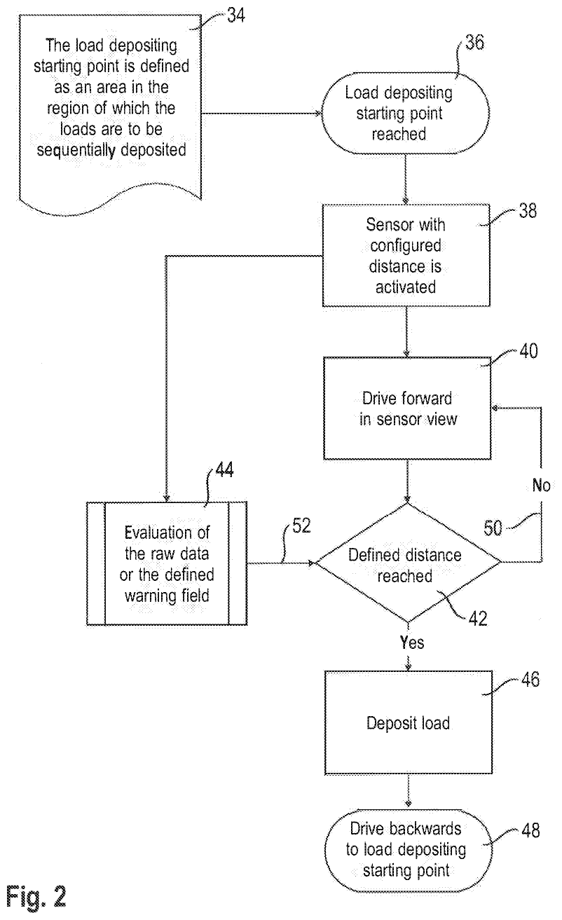

The procedure transpiring in the vehicle control in the industrial truck according to the invention is portrayed in FIG. 2. The procedure starts with step 34 in which a load depositing starting point is defined. The definition uses an area, or respectively a region in the area from which the loads should be deposited sequentially, i.e., along a row. This is horizontal block storage in which a given distance is provided between the individual stored materials. The intermediate space in this case can for example serve to make the individual loads more accessible.

Method step 36 starts once the load depositing starting point defined in step 34 is reached by the industrial truck. When the load depositing starting point is reached, a sensor is activated at a configured distance; this corresponds to step 38. In step 38, automatic operation is initiated in the vehicle control for horizontal block storage.

In an initial activation in step 38, the vehicle is driven forward a distance in a following step 40. Signal detection by the personal safety system is active during this travel of the industrial truck. In a following step 42, it is checked whether the defined distance has been reached by the vehicle. If this is the case, the load is deposited in step 46, and the vehicle returns to the load depositing starting point in step 48. If the defined distance has not been directly reached, the procedure returns to step 40 via the reference 50. Limited forward travel occurs again in step 40. The industrial truck creeps forward by the individual steps via the query 42 of whether the defined distance has been reached. An evaluation of the distance data from the distance measuring device occurs in step 44 for the query 42 of whether the defined distance has been reached. The distance data are evaluated in step 44 either as raw data, i.e., distance values, or with respect to the defined safety fields of the personal safety system. The distance data 52 obtained in this matter are based on the query of whether the desired distance has been reached.

With respect to the two versions in step 44 of evaluating the distance data, the desired distance between the load carriers for using the safety zone can already be set in the factory. In this case, an industrial truck is then delivered with safety zones that are already correspondingly set. If an evaluation of the raw data, i.e., the detected distance values, contrastingly occurs in step 44, the corresponding adaptation can be made after delivery with the assistance of a teach-in process. This means that the vehicle with a picked-up load is manually positioned once for the teach-in process at the desired distance from the prior load. The spacing ascertained through the raw data is saved, wherein the vehicle can then access the saved data in automatic operation and deposit the load at the defined distance. The advantage of this version is that a factory setting is unnecessary, and the customer himself, or a customer service technician can change and reset the distance as desired for the customer.

### LIST OF REFERENCE NUMBERS

10 Vehicle
12 Drive part
14 Load part
16 Control element
18 Lift mast
20 Vehicle control
22 Lifting member
24 Pallet
26 Pallet
28 Pallet
30 Length
32 Distance
34 Method step
36 Method step
38 Method step
40 Method step
42 Method step
44 Method step
46 Method step
48 Method step
50 Reference
52 Distance data

1. An industrial truck comprising:
a vehicle control configured for automatic operation;
a lifting member configured to be controlled in automatic operation;
a drive system configured to be controlled in automatic operation for automatic driving; and
a personal safety system comprising a distance measuring apparatus and configured to detect and evaluate at least one safety zone in front of the lifting member, wherein the distance measuring apparatus is configured to obtain distance data on objects and obstacles within the at least one safety zone,
wherein the vehicle control is configured to at least one of deposit and pick up a plurality of load carriers positioned at a predetermined distance from each other, and wherein the vehicle control is configured to access the distance data of the personal safety system in order to automatically control the lifting member and the drive system.

2. The industrial truck according to claim 1, wherein the personal safety system is configured to evaluate the distance data obtained from the distance measuring apparatus for the vehicle control.

3. The industrial truck according to claim 2, further comprising a teach-in function for at least one of the vehicle control and the personal safety system, wherein the teach-in function is configured to enable manual control of the industrial truck for a desired movement, wherein corresponding limit values and threshold values are set for parameters and distance values related to the desired movement, and wherein the vehicle control repeats the desired movement in automatic operation according to the parameters and distance values set the teach-in function.

4. The industrial truck according to claim 1, wherein the predetermined distance for the load carriers is recognized by the personal safety system and the at least one safety zone.

5. The industrial truck according to claim 1, wherein the drive system is controlled for automatic driving until the predetermined distance is recognized by the personal safety system.

6. The industrial truck according to claim 1, wherein at least one first safety zone is provided for personal safety, and wherein at least one second safety zone is provided for at least one of an automatic depositing and an automatic pickup process by load carriers at a given distance.

7. The industrial truck according to claim 6, wherein the at least one first safety zone is turned off for a duration of the at least one of an automatic depositing and an automatic pickup process.

8. The industrial truck according to claim 1, wherein the distance measuring apparatus comprises a laser scanner.

9. The industrial truck according to claim 1, wherein the lifting member comprises two load forks.

10. A method for automatically operating an industrial truck having a lifting member and a drive system, the method comprising:
detecting at least one safety zone in front of the lifting member;
obtaining distance data related to objects and obstacles within the at least one safety zone;
accessing the distance data by a vehicle control to automatically operating the lifting member and the drive system to pick up and deposit load carriers, wherein the load carriers are positioned at a predetermined distance from each other.
